(19) United States
(12) Patent Application Publication
(10) Pub. No.: US 2011/0017395 A1
(43) Pub. Date: Jan. 27, 2011

(54) Composite resin tile system

(76) Inventors: Joseph Loyd Vandiver, Elgin, SC (US); Harold Raymond Waynick, III, Sumter, SC (US)

Correspondence Address: MONAHAN & MOSES, LLC, 13-B W. WASHINGTON ST., GREENVILLE, SC, 29601, US

(21) Appl. No.: 12/460,518

(22) Filed: Jul. 21, 2009

(51) Int. Cl. B32B 37/02; C08K 3/22

(52) U.S. Cl. 156/280; 524/430; 156/153

(57) ABSTRACT

The composite resin tile system is essentially an inner sleeve formed from tiles that is applied to the inner walls of a Flue Gas Desulfurization scrubber/absorber system that forms part of an emission system in a plant that generates corrosive gases as a by-product of its process (such as a power plant), in order to provide chemical corrosion resistance and abrasion resistance. In a preferred embodiment, the novel corrosion and abrasion resistant material is formed from either vinyl ester resin or epoxy resin (about 60% to about 75% by weight) and aluminum oxide (about 25% to about 40% by weight). The instant material may be formed into interlocking tiles that are applied to the inner surfaces of Flue Gas Desulfurization components. This tile system is particularly useful in areas within the scrubber/absorber system where aqueous reagents and liquid waste are contained, transported, or used in the scrubbing/absorbing process.

### BACKGROUND OF THE INVENTION

The present invention relates generally to corrosion and abrasion resistant tiles that may be installed in structures used to carry or hold corrosive liquid materials and the like, such as power plant combustion emission systems or similar plant processes. More specifically, the present invention includes a system and method for producing and installing into such systems corrosion and abrasion resistant tiles that are formed from a composite material comprising a resin in combination with aluminum oxide, as well as other optional additives. These tiles are manufactured and installed within vessels that contain and carry liquid components within emissions structures, forming the inner walls of the structure that are in direct contact with the corrosive materials passing through the system. The tiles are installed either to repair existing vessels or structures that have become corroded over a period of time, or in the initial manufacture of such systems in order to improve corrosion, abrasion and chemical resistance of the vessels, thus significantly extending the life and functional duration of the system.

Flue gas desulfurization is commonly known as FGD and is the technology used for removing sulfur dioxide (SO₂) from the exhaust flue gases in power plants that burn coal or oil to produce steam for the steam turbines that drive their electricity generators. As a result of stringent environmental protection regulations regarding SO₂ emissions that have been enacted in a great many countries, SO₂ is now being removed from flue gases by a variety of methods, with the following being the most common: 1) Wet scrubbing using a slurry of alkaline sorbent, usually limestone or lime, or seawater to scrub the gases; and 2) Spray-dry scrubbing using similar sorbent slurries.

Alkaline sorbents are used for scrubbing flue gases to remove SO₂. Depending on the application, the two most important are lime and sodium hydroxide (also known as caustic soda). Lime is typically used on large coal or oil fired boilers as found in power plants, as it is very much less expensive the caustic soda. The use of lime results in a slurry of calcium sulfite (CaSO₃) that must be disposed of Fortunately, calcium sulfite can be oxidized to produce by-product gypsum (CaSO₄.2H₂O) which is marketable for use in the building products industry.

In these FGD systems, the reagent is injected in the flue gas in a spray tower or directly into the duct. The SO₂ is absorbed, neutralized and/or oxidized by the alkaline reagent into a solid compound, as discussed above. The solid is removed from the waste gas stream using downstream equipment.

Scrubbers are classified as “once through” or “regenerable”, based on how the solids generated by the process are handled. Once-through systems either dispose of the spent sorbent as a waster or utilize it as a byproduct. Regenerable systems recycle the sorbent back into the system.

In a wet scrubber system, flue gas is ducted to a spray tower where an aqueous slurry of sorbent is injected into the flue gas. To provide good contact between the waste gas and sorbent, the nozzles and injection locations are designed to optimize the size and density of slurry droplets formed by the system. A portion of the water in the slurry is evaporated and the waste gas stream becomes saturated with water vapor. Sulfur dioxide dissolves into the slurry droplets where it reacts with the alkaline particulates. The slurry falls to the bottom of the absorber where it is collected. Treated flue gas passes through a mist eliminator before exiting the absorber which removes any entrained slurry droplets. The absorber effluent is sent to a reaction tank where the SO₂ alkali reaction is completed forming a neutral salt. In a regenerable system, the spent slurry is recycled back to the absorber.

Semi-dry systems, or spray dryers, inject an aqueous sorbent slurry similar to a wet system, however, the slurry has a higher sorbent concentration. As the hot flue gas mixes with the slurry solution, water from the slurry is evaporated. The water that remains on the solid sorbent enhances the reaction with SO₂. The process forms a dry waste product which is collected and either disposed, sold as a byproduct or recycled to the slurry. The reagent slurry is injected through rotary atomizers or dual-fluid nozzles to create a finer droplet spray than wet scrubber systems.

The scrubber structures where these reactions take place are exposed to high acid concentrations (including H₂SO₄), entrained and suspended particulates, and wet/dry interfaces of the condensing acids from suspension in the gaseous flue gas stream. The SO₂, SO₃, and H₂SO₄ combined with the high temperatures and physical interaction between the gaseous emissions and the scrubbing reagents can cause significant erosion and corrosion of the scrubber system structure.

When the emissions scrubbing structures of power plants, or other similar structures, become corroded, eroded or otherwise degraded from years of exposure to such conditions, it becomes necessary to repair and maintain these systems. Replacing such systems can be prohibitively expensive, so other means for extending the life of the emissions systems have been developed. One way that has been utilized commercially to extend the life of these systems is by providing coatings or liners within the various scrubber/absorber components that carry or hold the aqueous reagents and liquid waste. These liners are typically applied to the inside of the vessels, absorbers, misters, holding tanks, and other structures used to carry the aqueous materials. These liners and coatings are used to protect the emissions structures primarily against chemical corrosion. One disadvantage to using such liners and coatings for these applications is that they do not typically provide the necessary corrosion and abrasion resistance, thereby reducing their effective lifespan within the system.

Within the scrubber/absorber vessels and structures are areas that experience increased turbulence, which are usually caused by the scrubbing action and interaction between the gaseous emissions and the scrubbing reagents. In these “target zones,” the corrosive gases together with the cleansing liquids directly impact the walls of the structure. Thus, the target zones show increased evidence of erosion due to the corrosion and abrasion created by the scrubbing action and corrosive gas flow within the system. Increased corrosion and abrasion resistance is required in the target zones, in order to increase the functional life of the scrubber/absorber systems in these areas.

Thus, it would be desirable to provide a material that could be formed into tiles and applied within scrubber/absorber elements of emissions structures, in order to increase corrosion and abrasion resistance, particularly in the target zones. It would also be desirable to provide a method for installing such corrosion and abrasion resistant materials within such structures.

### OBJECTS OF THE INVENTION

Therefore, it is an object of the present invention to provide a corrosion and abrasion resistant material for installation against the interior surfaces of power plant emissions structures, specifically within areas exposed to the aqueous scrubbing reagents and corrosive gases together, in order to form an inner sleeve that increases resistance to chemical corrosion, abrasion and erosion.

Additionally, it is an object of the present invention to provide a composite material that may be formed into tiles, wherein the composite includes a resin, aluminum oxide, and optionally may contain other additives.

Further, it is an object of the present invention to provide a composite material that may be installed directly and adhered to other lining materials installed in such a way as to form an additional, corrosion and abrasion resistant layer to form a tile-based corrosion and abrasion resistant protective system.

### SUMMARY OF THE INVENTION

In a preferred embodiment, the corrosion and abrasion resistant material is formed from a resin (about 60% to about 75% by weight), and aluminum oxide (about 25% to about 40% by weight). Preferred resins include vinyl ester resin and epoxy resin. In order to prepare the material, the resin is mixed together with the aluminum oxide. Additional components may be included, including powdered ceramics or vermiculite (preferably up to about 10% by weight) for additional corrosion and abrasion resistance, weight reduction and increased insulative properties, when necessary. One advantage of using epoxy resins is that such use limits the amount of volatile organic compounds during the installation of the tiles.

The mixture is then cast into molds that provide a texturized mounting surface on one side, so that an adhesive layer may be applied thereto, which helps to form a strong bond during installation. The material is then cured, preferably at 150 F for several hours. After curing, the composite material is removed from the mold. In one embodiment, the tiles are formed with interlocking edges which are engaged when the tiles are installed. These tiles may then be applied to the inner surfaces of a scrubber/absorber system (such as the inner surfaces of the scrubber/absorber, liquid holding tanks, liquid transport pipes, and any other portion of the emission system that is exposed to the aqueous reagents used in the scrubbing process) by using commercially available corrosion inhibiting adhesives, grouts and mortars.

In order to install the tiles into an emissions structure, the tiles are adhered to the inner faces of existing walls, ceilings and/or floors of the structure. Essentially, the tiles are used to form an inner sleeve within the existing emissions structure, where the inner sleeve comprises walls formed from the tiles. This tile system is particularly useful in areas within the scrubber/absorber system where aqueous reagents and liquid waste are contained, transported, or used in the scrubbing/absorbing process.

### BRIEF DESCRIPTION OF THE DRAWINGS

These and other features, aspects, and advantages of the present invention will become better understood with regard to the following description, appended claims, and accompanying drawings where:

FIG. 1 is a perspective cut-away view of one embodiment of the corrosion and abrasion resistant tile section installed within an absorber;

FIG. 2 is a close-up perspective cut-away view of the spray zone section of the absorber shown in FIG. 2;

FIG. 3 is a perspective view of a one embodiment of single tile;

FIG. 3A is a perspective view of two interlocking tiles; and

FIG. 4 is a side view of a single tile in accordance with one embodiment of the present invention.

### DETAILED DESCRIPTION OF THE INVENTION

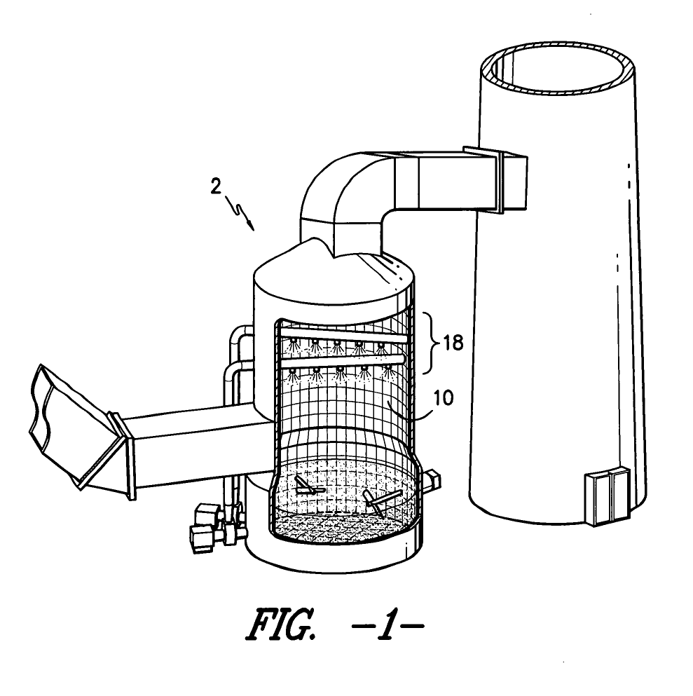

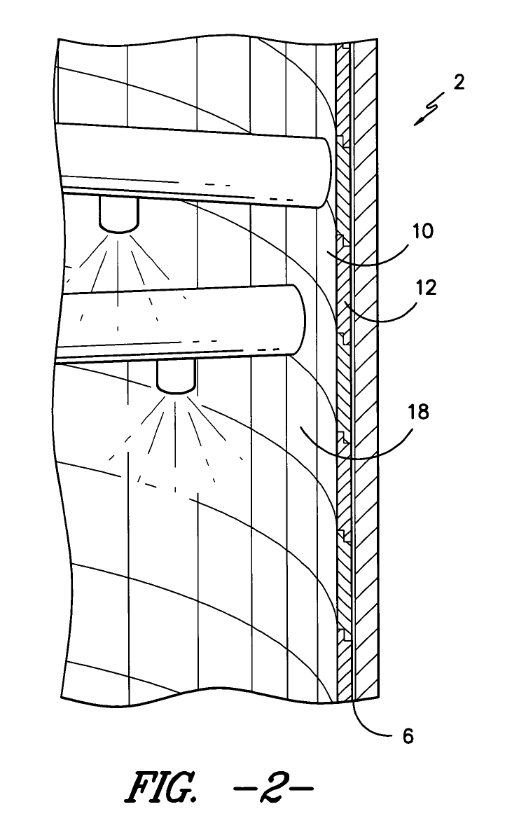

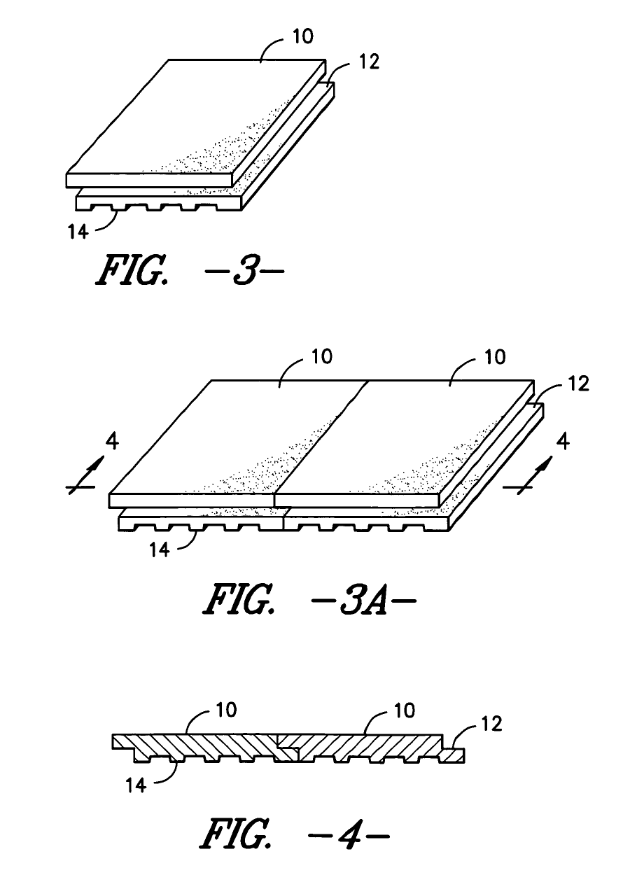

A first embodiment of the abrasive resistant tile system is shown in FIG. 1. The tile system is essentially a protective inner sleeve 18 comprising interlocking tiles 10 that are applied to the inner walls of a wet or semi-dry scrubber/absorber system within an emissions system or structure 2 in plant that generates corrosive gases as a by-product of its process (such as a coal or fossil fuel burning power plant). The inner sleeve 18 comprises tiles 10 formed from a resin (about 60% to about 75% by weight) and aluminum oxide (about 25% to about 40% by weight). Preferred resins include vinyl ester resins and epoxy resins. The use of epoxy resins reduces the amount of volatile organic compounds during installation of the tiles into the system.

In order to prepare the composite material, the resin is mixed together with the aluminum oxide and a curing catalyst. Examples of preferred catalysts include diaroyl peroxide, tertiary alkyl hydroperoxides, and alkyl peresters of percarboxylic acids, although other known catalysts may be used. Additional components may be included, including powdered ceramics or vermiculite (preferably up to about 10% by weight) for increased corrosion and abrasion resistance and weight reduction, when necessary.

The mixture is then cast into molds that provide a rough or texturized mounting surface 14 on one side, so that an adhesive layer may be applied thereto, which helps to form a strong bond during installation. The composite material is then cured, and may optionally be heated at 150 F for several hours to accelerate the process of curing and enhance the physical properties. After curing, the tiles are removed from the mold. The tiles are formed with interlocking edges 12 that are engaged with each other upon installation of the tiles 10. These tiles 10 may then be applied to the inner surfaces of an emissions structure as described herein (or to the inner walls of any structure that requires such abrasive resistant properties) by using commercially available corrosion inhibiting adhesives, grouts and mortars. These tiles are particularly useful in areas within the scrubber/absorber system where aqueous reagents used in the scrubbing process are transported, contained, and/or exposed to gaseous emissions streams. These areas typically include holding tanks, transport pipes, vessels where the gaseous emissions scrubbing takes place, and the like.

To install the tiles 10 into such a structure 2, it may be desirable to clean the inner surfaces of the structure 2 by performing abrasive blasting, such as sand blasting those surfaces. In some cases, it may be desirable to provide a roughened surface of the underlying structure (SP-5 with 3-5 mil peak/peak profile for steel). A primer 6 is then applied to the structure surface to enhance adhesion between the structure surface and the tiles. Preferred primers include vinyl ester resin or epoxy resin primers. In a preferred embodiment, a varied combination of layers of flake glass and vinyl ester are applied on top of the primer 6, either by spraying or by trowel, with the final layer preferably being a trowel applied vinyl ester resin based mortar. The tiles 10 are then pressed onto the mortar in such a way that the interlocking edges 12 of the tile engage each other. Alternatively, epoxy resins or other suitable corrosion inhibiting adhesives may be used in place of vinyl ester resins for adhesive purposes. Commercially available corrosion inhibiting adhesives, grouts and mortars may be used for such installation.

This arrangement allows a corrosion and abrasion resistant inner sleeve 18 to be quickly and easily installed within an emissions structure, vessel, either in its entirety or in specific areas where the need for extremely robust corrosion and abrasion protection is needed on a localized basis. Further, the instant composite resin tile system allows for the tiles 10 to be chemically bonded into a monolithic system (and strengthened by the interlocking aspects of the tile) as opposed to other glazed tile/cementitious systems that rely on mechanical methods of adhesion.

Optionally, a ceramic epoxy paste may be used as an adhesive agent for installing the tiles to the inner surfaces of the emissions structure. Additionally, the tiles may then be overcoated with the ceramic epoxy paste layer.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A corrosion and abrasion resistant tile made from a composite material comprising aluminum oxide and a resin selected from the group consisting of vinyl ester resin and epoxy resin.

2. The corrosion and abrasion resistant tile set forth in claim 1, wherein said composite material comprises by weight from about 60% to about 75% vinyl ester resin, and from about 25% to about 40% aluminum oxide.

3. The corrosion and abrasion resistant tile set forth in claim 1, wherein said composite material further comprises a curing catalyst.

4. The corrosion and abrasion resistant tile set forth in claim 1, wherein said composite material further comprises material selected from the group consisting of powdered ceramics and vermiculite.

5. The corrosion and abrasion resistant tile set forth in claim 1, wherein said tile includes interlocking edges, so that each said tile may interlock with an adjacent tile upon installation.

6. A process for installing a corrosion and abrasion resistant inner sleeve to the inner surfaces of a structure used to carry or contain corrosive materials and the like, said process comprising the steps of:
cleaning said inner surfaces of said structure;
applying an adhesive agent to said inner surfaces of said structure;
adhering corrosion and abrasion resistant tiles, comprising a composite material including aluminum oxide and a resin selected from the group consisting of vinyl ester resin and epoxy resin, to said inner surfaces of said structure; and
applying adhesive, grout or mortar, or some combination thereof, between said corrosion and abrasion resistant tiles.

7. The process set forth in claim 6, further including the step of applying a ceramic epoxy paste to the outer surfaces of said abrasive resistant tiles.

8. The process set forth in claim 6, wherein said composite material of said corrosion and abrasion resistant tiles comprises by weight from about 60% to about 75% resin, and from about 25% to about 40% aluminum oxide.

9. The process set forth in claim 6, wherein said composite material of said corrosion and abrasion resistant tiles further comprises a curing catalyst.

10. The process set forth in claim 6, wherein said composite material of said corrosion and abrasion resistant tiles further comprises material selected from the group consisting of powdered ceramics and vermiculite.

11. The process set forth in claim 6, wherein said adhesive agent is selected from the group consisting of vinyl ester resin, epoxy resin and a ceramic epoxy paste.

12. The process set forth in claim 6, wherein the step of cleaning said inner surfaces of said structure includes abrasive blasting of said inner surfaces.
